(19) United States
(12) Patent Application Publication
(10) Pub. No.: US 2002/0154354 A1
(43) Pub. Date: Oct. 24, 2002

(54) Optically interconnecting multiple processors

(76) Inventors: Kannan Raj, Chandler, AZ (US); Werner Metz, Chandler, AZ (US)

Correspondence Address: Timothy N. Trop, TROP, PRUNER & HU, P.C., 8554 KATY FWY, STE 100, HOUSTON, TX, 77024-1805, US

(21) Appl. No.: 09/839,023

(22) Filed: Apr. 20, 2001

(51) Int. Cl. H04J 14/02; H04B 10/00

(52) U.S. Cl. 359/124; 359/152

(57) ABSTRACT

A multiprocessor system may include a plurality of processors that are optically coupled to one another. An optical transceiver may send messages to other processors using a preassigned wavelength. Each message from one of the other processors in the system may be received by a given processor. The messages from any given processor may include a code that identifies the sending and receiving processors. When a given processor is receiving a signal from another processor, it may provide an indication to the other processors in the system that it is occupied and will not accept any transmissions.

### BACKGROUND

This invention relates generally to multiprocessor systems.

Multiprocessor systems include a plurality of processors that are interconnected. A processing job may be divided into a plurality of tasks handled by separate processors in a system, dramatically improving the capabilities of the system. In addition, multiprocessor systems used as servers may have improved reliability, availability, and service. Currently, four processor systems are known and there is a progression towards eight and sixteen processor systems.

As more and more processors, working at relatively high speeds, become connected together, electrical interconnect bottlenecks and power considerations may limit ultimately achievable performance. Multiprocessor servers increase system memory and input/output bandwidth requirements. They also increase packing density and thermal loads on printed circuit boards.

Since processor speeds are increasing at a steady rate while system input/output speed is lagging far behind, it may be that in future processors, the ratio of bus speed to processor speed will be much less than one. One reason for this lag is that electrical interconnects impose a performance overhead that translates to reduce operating frequencies. Also, in copper links, the bandwidth does not scale well with increased numbers of links. Electrical interconnects on copper are also facing a daunting challenge in terms of electromagnetic interference mitigation at very high data rates. These data rates may also raise safety concerns due to increased radiation hazards.

Multiprocessor systems may be connected together on a printed circuit board. Alternatively, a number of processors may be integrated together into the same die. Conventionally, a plurality of processors are connected by a front side bus that in turn couples to a system memory and input/output connections. Since the processors can only communicate with each other through the front side bus, communications may be relatively slow.

Thus, there is a need for better ways to interconnect processors in multiprocessor systems.

### BRIEF DESCRIPTION OF THE DRAWINGS

FIG. 1 is a schematic depiction of a multiprocessor system in accordance with one embodiment of the present invention;

FIG. 2 is a schematic depiction of a transceiver for one processor in accordance with one embodiment of the present invention;

FIG. 3A is a flow chart for software utilized by the optical transceiver in accordance with one embodiment of the present invention;

FIG. 3B is a flow chart for software utilized by the optical transceiver in accordance with one embodiment of the present invention;

FIG. 4 is a schematic depiction of a wavelength division multiplexer in accordance with one embodiment of the present invention;

FIG. 5 is an enlarged view of one of the mirrors used in the embodiment shown in FIG. 1 in accordance with one embodiment of the present invention; and

FIG. 6 is an enlarged cross sectional view taken generally along the line 6-6 in FIG. 4.

### DETAILED DESCRIPTION

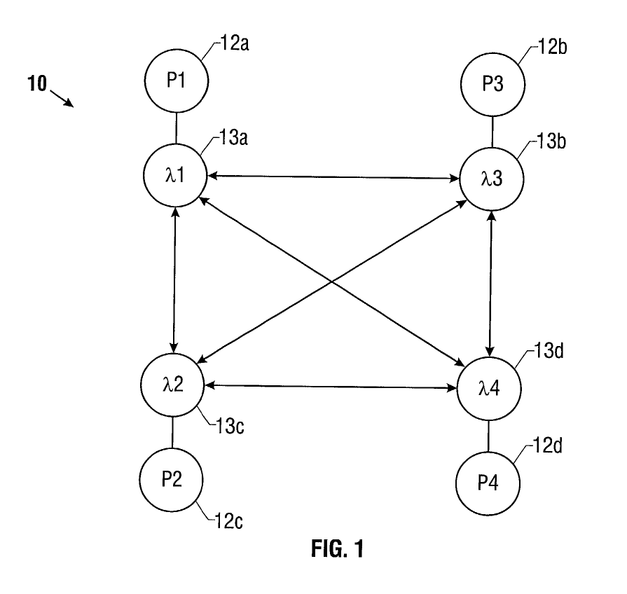

Referring to FIG. 1, a multiprocessor system 10 may include a plurality of processors 12. In the embodiment illustrated in FIG. 1, four processors 12a, 12b, 12c, and 12d are optically interconnected, as indicated by the arrows, to one another. However, the system 10 may include three or more processors in other embodiments. Each processor 12 has an assigned wavelength for communicating with the other processors 12. Thus, the processor 12a may use wavelength one, the processor 12b may have the wavelength three, processor 12c may use wavelength two, and the processor 12d may use wavelength four.

Each processor 12 can send a wavelength division multiplexed (WDM) signal to each of the other processors 12 using a wavelength division multiplexer 13 and can receive data using a demultiplexer 13. Each processor 12 transmits data at its own assigned wavelength. Similarly, each processor 12 receives data at all the transmitting wavelengths used by the other processors 12 in the system 10. Thus, each processor 12 may include a light source, such as a laser, that transmits at the assigned wavelength. In one embodiment, Vertical Cavity Surface Emitting Lasers (VCSELs) may be utilized. Other suitable lasers include edge-emitting lasers.

While each multiplexer 13 may receive light at all transmitting wavelengths of the other processors 12, each multiplexer 13 at any time may be locked onto one input wavelength in a data receive lock mode. In other words, each receiver, linked to its demultiplexer 13, does not receive a plurality of different wavelengths (each associated with a transmission from another processor 12) at the same time, but instead determines one inbound wavelength to lock to and receives data exclusively on that wavelength for a period of time in one embodiment. Each processor 12 communicates optically only with one other processor 12 in the system 10 at a time in one embodiment of the present invention.

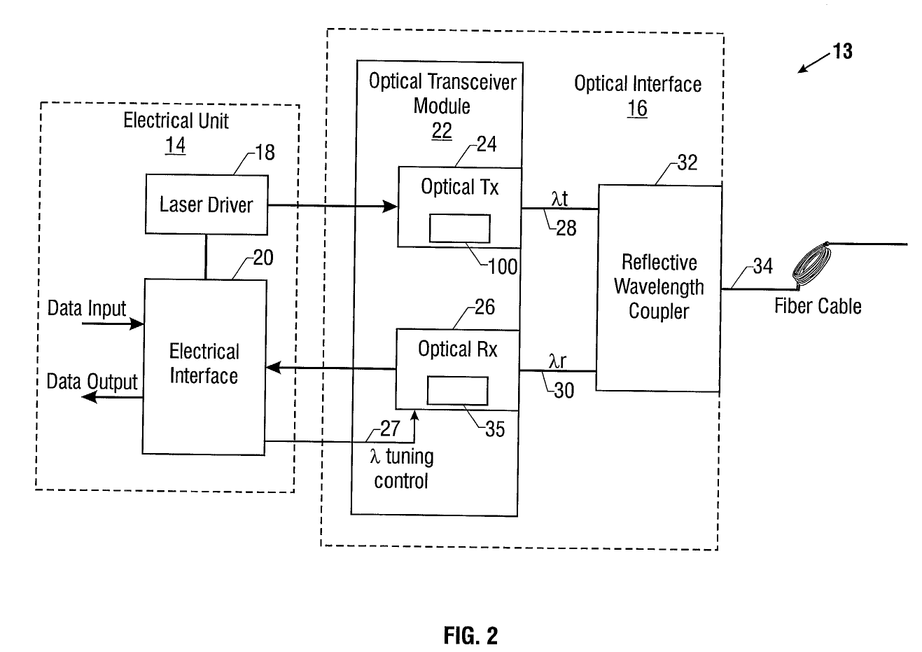

Referring to FIG. 2, an optical interface 16 and an electrical unit 14 may act as the multiplexer 13 between each processor 12 and the other processors 12 in the system 10. Thus, a fiber cable 34 may couple the multiplexer 13 of one processor 12 (coupled to the data input and output signals of FIG. 2) to all the other processors 12 in the system 10.

The optical interface 16 may include a reflective wavelength coupler 32 that directly couples to a plurality of optical fibers contained within the fiber cable 34. The reflective wavelength coupler 32 transmits optical signals to the fiber cable 34 and receives signals from the fiber cable 34. The incoming signals are transferred to the optical receiver 26 and outgoing signals are received from the optical transmitter 24. The optical transmitter 24 and receiver 26 together form an optical transceiver module 22. The optical transmitter 24 may be a Vertical Cavity Surface Emitting Laser (VCSEL) or an edge-emitting laser, as two examples.

The transmitter 24 and the receiver 26 may be integrated together in one embodiment. In such case, the optical receiver 26 may include an optical detector such as a reverse biased PN junction diode, a PIN diode, a PNP transistor, or a metal-semiconductor-metal (MSM) detector. Monolithic integration of the receiver 24 and transmitter 26 may be accomplished using group III-V materials.

The optical transceiver module 22 of the optical interface 16 communicates with the electrical unit 14. The electrical unit 14 powers the optical transmitter 24 using a laser driver 18. The electrical unit 14 also receives optical signals in an electrical interface 20 and converts them into a suitable electrical signal format. Data input and output signals may be received at the interface 20 from a processor 12 (not shown in FIG. 2).

A multiplexer 13 may be associated with each processor 12. The electrical interface 20 may supply a wavelength tuning control signal 27 to the optical receiver 26. The signal 27 tunes the optical receiver 26 to a particular transmission wavelength assigned to a particular processor 12 in the system 10. Thus, the output wavelength signal 28 may be provided by the transmitter 24 to the coupler 32 and eventually to the cable 34. Conversely, an inbound optical signal 30 from the cable 34 may be provided by the coupler 32 to the optical receiver 26.

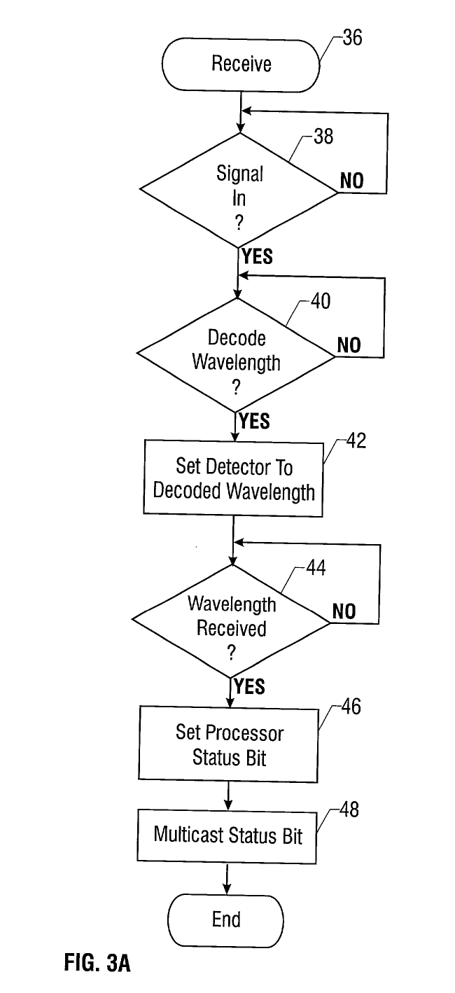

In accordance with one embodiment of the present invention, the optical receiver 26 may be (or may be associated with) a processor-based system including a storage 35 that stores the software 36 shown in FIG. 3. The software 36 controls communications with a given processor 12.

In a multiprocessor system 10, data transmitted from every processor 12 to every other processor 12 coexists on the same physical medium such as a single mode fiber or a multi-mode fiber, with the data encoded on multiple wavelengths. As a result, contention may arise between two or more processors 12 wanting to communicate with another processor 12 at the same time, with two or many processors wanting to access or write to the same memory location. To resolve contention, a transaction protocol may be based on wavelength selection by code matching. Each processor 12 starts a transmission with a unique code at a known wavelength. The optical receivers 26 associated with each processor 12 sweep through the known wavelengths associated with each of the other processors 12 over a known tuning range and sequence within a given time slot. Thus, a receiver 26 may sweep the sequence of known wavelengths associated with each of the other processors 12 in the system 10.

Whenever the optical receiver 26 identifies a match of a code and wavelength, a transmit-receive pair is established. The optical receiver 26 is then locked to that wavelength until the transaction for that receive/transmit pair is complete. The wavelength locking is achieved by the wavelength tuning control signal 27 supplied from the interface 20 to the optical receiver 26. Thus, after locking, the optical receiver 26 is tuned to the chosen wavelength associated with the chosen transmitting processor 12. As a result, an exclusive communication pair is established between two processors 12, one of which is tuned to the transmission wavelength of the other.

Each processor 12 causes its optical interface 16 to transmit data at its assigned wavelength. Each processor 12 also causes the optical interface 16 to detect an incoming beam of light at the preassigned wavelengths associated with each of the other processors 12 in the system 10. The optical receiver 26 scans for particular wavelengths and also checks for codes associated with those wavelengths.

In particular, when a particular processor 12 wants to communicate with another processor 12, it causes its transmitter to send a signal using its assigned wavelength together with a code that identifies the sending processor 12 and an intended target or receiving processor 12 and is multiplexed onto the single mode or multi-mode fiber. In addition, each processor 12 causes the optical interface 16 to use wavelength locking to receive data.

The optical receiver 26 tuning is done in sequence. When the code is matched with the receiving processor 12 at the wavelength of interest, the wavelength is locked for that receiver 26. The receiver 26 indicates a processor “busy” flag for all other processors 12 until it sets a processor “free” flag for all other processors 12. All other processors 12 may refrain from transmitting to the busy processor 12 until they detect the processor free flag, in accordance with one embodiment of the present invention.

Thus, referring to FIG. 3A, in one embodiment, the receive software 36 initially determines whether a signal has been received at one of the scanned wavelengths as determined in diamond 38. In one embodiment, an inbound signal received by the receiver 26 may be subjected to transimpedance amplification before wavelength decoding. The transimpedance amplifier may be monolithically integrated onto the detector or may be a separate die. In another embodiment, both the transmit and receive ports may be monolithically integrated on a single opto-electronic integrated circuit. The wavelength of the inbound signal is determined and the intended recipient code is decoded as indicated in diamond 40. If the signal is intended for the receiving processor 12, as determined by the accompanying code, its optical receiver 26 is set to the decoded wavelength using the wavelength tuning control signal 27, as indicated in block 42.

When the wavelength signal is received, as determined in diamond 44, the processor busy flag or status bit is set as indicated in block 46. The status bit may then be multicast to all the other processors 12 in the system 10 in accordance with one embodiment of the present invention, indicated in block 48. When the communication is completed, the processor free bit may be set.

Each of the processors 12 reads the processor busy bit. This may be achieved in a variety of ways. As one example, an electrical signaling option may be used. Each processor 12 may indicate its transmission status by setting a bit in a processor status register. This register may be accessible for reading by all the other processors in the system 10. Another alternative is to initiate an optical multicast. In one embodiment, each processor 12 may indicate its transmission status at predetermined time intervals. In each case, the processor 12 may indicate not only that it is locked, but it may also indicate which processor it is locked to or receiving data from.

Referring to FIG. 3B, the transmit software 100 may be stored for example in connection with the optical transmitter 24. The optical transmitter 24 may be a processor-based system in one embodiment. Alternatively, the optical transceiver module 22 may be a processor-based system that includes a storage that stores the software 35 and 100.

The software 100 begin by receiving electrical data from a processor 12 for transmission to another processor as indicated in block 102. That data is converted into an optical signal and wavelength division multiplexed as indicated in block 104. In addition, a code is developed that indicates the transmitting processor 12 as well as the recipient processor 12 as indicated in block 106. The data and the code is then transmitted as indicated in block 108.

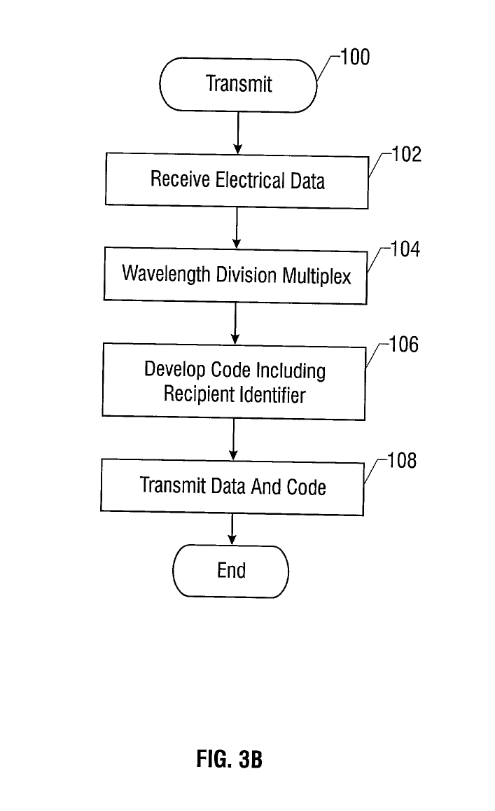

The coupler 32, shown in FIG. 4, may include fiber arrays 88 and 120 in one embodiment. The fiber array 88 may be coupled to the receiver 26 while the fiber array 120 may be coupled to the transmitter 24. The coupler 32 may include a reflector system using an elliptical reflector 82. Each of the wavelength specific light beams received from one of the arrays 88 or 120 is reflected by the elliptical reflector 82. The light beams, received at a foci S1 through S8 of the elliptical reflector 82, are reflected toward corresponding or conjugate foci S9 through S16 (or vice versa). The number of light beams, and the precise orientation of the optical reflector 82 is subject to considerable variability. The present invention is not limited to a specific orientation of an elliptical reflector 82 or the use of a specific number of wavelengths.

In accordance with conventional geometry, any light beam issuing from a focus of the electrical reflector 82 is reflected to a conjugate focus of the elliptical reflector 82, regardless of the orientation and direction of the light beam. Thus, a one-to-one imaging and coupling may be created between the coupler 32 issuing the light beam through one set of foci Si to S8 and the light directed towards conjugate foci S9 to S16 (or vice versa).

A dispersive element 112, such as a reflection phase grating, a thin film dielectric grating, a prism, or a microelectomechanical structure (MEMS) contributes to the creation of multiple foci S1 through S16. The dispersive element 112 may be positioned optically between the reflector 82 and a fiber array 88.

Each of the light beams of a different wavelength on a fiber in an array 88 or 120 may be reflected by the reflector 82 from a first plurality of multiple foci S1-S8 towards a second plurality of conjugate foci S9-S16 (or vice versa). However, before reaching the second set of conjugate foci, the light beam is reflected by the dispersive element 112 to a common focal point that corresponds to the end of an optical fiber in an array 88 or 120.

The cable 34 (including the array 88) may be made up of dispersion-shifted fibers (DSF) or dispersion compensated fibers (DCF) as two examples. Both the DSF and DCF can support high data rates at low attenuation. To prevent cross coupling of transmitted data due to back reflections from a fiber on a receive channel into the optical transmitter 24, an angle polished fiber (APC) may be used. In one embodiment of the present invention, a polish angle of eight degrees may be suitable.

An optical block 85 may include a substantially transparent block of material. The elliptical reflector 82 may be placed at a predetermined location or locations on the block 85. The block 85 may, for example, be made of borosilicate. The dispersive element 112 may then be patterned on an edge of the optical block 85, in accordance with one embodiment of the present invention, or a MEMS may be used as the element 112.

Each receiver detects and discriminates the wavelengths used by all the other multiplexers 13 in the system 10. This may be accomplished by wavelength demultiplexing. Each multiplexer 13 may have a detector tuned to a particular wavelength. Suitable detectors include reverse biased PN junction diodes, PIN diodes, PNP transmitters or metal-semiconductor-metal (MSM) detectors. Also, wavelength tuned detectors such as resonant cavity detectors (RCD) may be used.

The block 85 thickness, the dispersive element 112 grating parameters and the ellipticity of the elliptical reflector 82 may be determined by the wavelengths and wavelength spacing. Ray tracing and known grating equation formulations may be used to position these elements. Aligning the optical block 85 to the arrays 88 and 120 may be facilitated by the use of fiducial marks on the arrays 88 and 120, the optical block 85, and the support 90 for the optical fibers in the arrays 88 or 120.

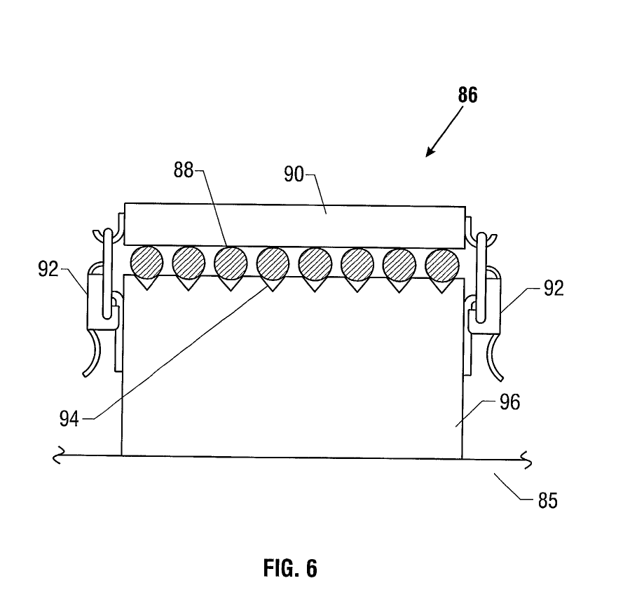

The optical block 85 may hold the elliptical reflector 82 in a securement system 86 for the optical fibers in the arrays 88 or 120. As shown in FIG. 6, the securement system 86 may include a top plate 90 clamped to a support 96 by a pair of securement devices 92 that may be clamps as one example. Each securement device 92 engages the top plate 90 and pulls it downwardly, causing an optical fiber in an array 88 or 120 to be sandwiched between the top plate 90 and the support 96, in a V-shaped groove 94.

A V-shaped groove 94 may be etched into the surface of the support 96. The support 96 may be made of silicon or thermoplastic material as examples. The x and y alignment of each fiber in an array 88 or 120 is controlled by placing each fiber 88 on a V-shaped groove 94. The V-shaped groove 94 may be centered in alignment with the conjugate foci S1-S16 relative to the dispersive element 112. The height of the V-shaped groove 94 is compatible with the diameter of the optical fiber in an array 88 or 120 to be coupled.

The optical block 85 provides for precise location of the fibers making up each array 88 or 120. Additionally, the reflector 82 may be held by the optical block 85 so that the major axis of the reflector 82 is coincident with light input and the minor axis is perpendicular to the midpoint of the foci. The optical block 85 may be include a pair of mating halves in some embodiments. The optical block 85 may also provide a stop or end point for accurately positioning the ends of the optical fibers.

The elliptical reflector 82 may be a reflective ellipsoid or a conic section placed on one side of the optical block 85. The reflector 82 may be secured with adhesive to the optical block 85 in one embodiment. An elliptical reflector 82 may be made by replication of a diamond turned master or by injection molding to manufacture in high volumes. Aluminum, silver, or gold coatings, as examples, may be applied to the reflector 82 to create a highly reflecting surface. While fixed positioning of the elliptical reflector 82 is illustrated in FIG. 4, the reflector 82 may be adjustable for precise alignment of the reflector 82 with the dispersive element 112 and the fiber arrays 88 and 120.

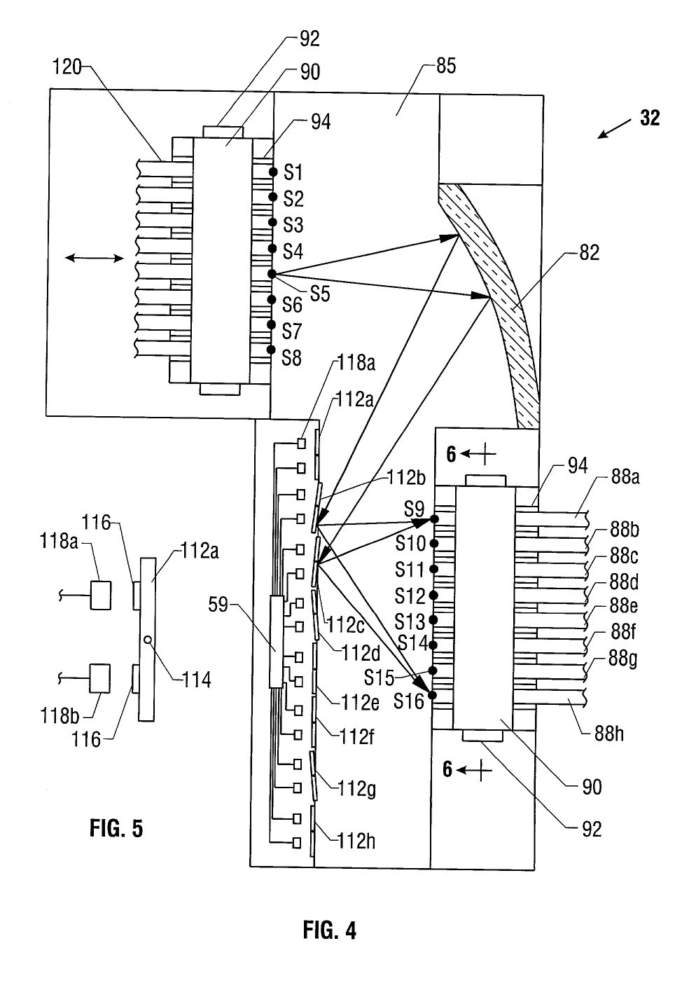

The coupler 32 may include a plurality of microelectromechanical structures (MEMS) acting as the element 112. Each of the structures forming the element 112 pivots around at least one (if not more) axis. In one embodiment, each MEMS element 112 may be tilted at the top, outwardly at the bottom, or may be maintained relatively untilted to vary the angle of reflection of light beams reflected by the reflector 82, as shown in FIG. 5.

Referring to FIG. 5, each MEMS element 112, such as the mirror 112a-h, includes a pivot 114 that mounts the mirror 112a-h for pivotal rotation or control of contacts 118a and 118b. Mating contacts 116 are provided on the backside of the mirror 112a-h. Thus, by placing appropriate charges on a contact 118a or 118b, the contact 116a or 116b may be attracted or repelled to adjust the angle of orientation of the mirror 112a-h. Signals provided to the contact 118a and 118b may be provided from an integrated circuit 119 that generates signals with appropriate timing to implement selected combinations of output signals for particular fibers in an array 88 or 120.

Each of the fibers in an array 88 or 120 may be mounted on V-shaped grooves 94 and held between a top plate 90a and a support 96 by the clamps 92. Thus, a plurality of grooves 94 hold a plurality of output fibers 88, 120 clamped between a top plate 90 and a support 96, as shown in FIG. 6. In this way, the focal point of any given fiber 88 or 120 may be the target of a particular mirror 112a-h whose position is controlled by the integrated circuit 119.

Each of the free ends of the fibers in the array 120 (eight of which are shown in FIG. 4) define a focus of an elliptical reflector 82, also secured to the optical block 85. The reflector 82 reflects light from each and every one of the fibers in the array 120 towards a MEMS element 112 including a plurality of mirrors 112a-h in a number equal to the number of fibers. In other words, each fiber in the array 120 has a corresponding mirror 112a through 112h assigned to it. Thus, each fiber controls the route each output signal from a given fiber to a given output fiber 88a through 88h in one embodiment. The output fibers 88 also include a securement system including the clamps 92, the V-shaped grooves 94, and top plate 90, which together collectively secure a plurality of fibers 88 with their free ends abutted against the optical block 85.

In this way, the ultimate disposition of each channel on each fiber 120 may be controlled by the element 112 to specifically direct or route each input channel to a particular output fiber 88.

Thus, in one embodiment of the present invention, using four processors 12, each processor may receive three input fibers 88a through 88c while using three output fibers 88d, 88e, 88f, each to communicate with a different one of the processors 12 in the system 10. A pair of status fibers 889 and 88h may be provided in one embodiment of the present invention. The status fiber 88g may provide output information to be broadcast to the other processors 12 indicating whether a given processor 12 is currently in a busy state because it is engaged in receiving a communication from another processor 12. The fiber 88h may be utilized to obtain status information from other processors 12 in the system, in accordance with one embodiment of the present invention.

While the mirrors 112a through 112h are shown in a one-dimensional arrangement, two dimensional arrays of MEMS may also be utilized in some embodiments. By integrating the coupler 32 with other components, relatively compact and potentially low loss arrangements are possible.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
a least three processors; and
an optical transceiver coupled to each processor, each transceiver including a wavelength division multiplexer to enable optical communication with the other two processors.

2. The system of claim 1 wherein each transceiver includes an optical transmitter including a laser.

3. The system of claim 1 wherein each transceiver includes an optical receiver tunable to a particular input wavelength.

4. The system of claim 1 wherein each processor is assigned a wavelength for communicating with the other processors.

5. The system of claim 1 wherein said transceiver includes a reflective wavelength coupler.

6. The system of claim 5 wherein said reflective wavelength coupler includes an elliptical reflector.

7. The system of claim 6 wherein said coupler includes an dispersive element to disperse light reflected by said reflector.

8. The system of claim 7 wherein said dispersive element includes a microelectromechanical structure.

9. The system of claim 1 wherein each transceiver transmits a light beam together with a code identifying a sending and a receiving processor.

10. The system of claim 1 wherein, when one processor is receiving a wavelength division multiplexed signal from another processor, the one processor broadcasts to all other processors that the one processor is busy.

11. A method comprising:
establishing a system including at least three processors; and
enabling optical communications between said processors using wavelength division multiplexing.

12. The method of claim 11 including assigning a unique wavelength to each of said processors.

13. The method of claim 11 including scanning for the wavelengths of any of said other processors.

14. The method of claim 13 including transmitting a light beam having a predetermined wavelength, and transmitting a code that identifies the transmitting processor and the intended receiving processor.

15. The method of claim 14 wherein the receiving processor identifies the wavelength of the incoming beam and the code accompanying said beam, and locks to the wavelength of the transmitting processor.

16. The method of claim 15 including notifying a first processor when a second processor is receiving a beam from a third processor.

17. The method of claim 16 including broadcasting the fact that the second processor is receiving a beam to all other processors in the system.

18. The method of claim 17 indicating when said second processor is no longer communicating with said third processor.

19. The method of claim 19 including using a code transmitted by the third processor to determine if a given processor is the intended recipient of a beam transmitted from the third processor.

20. The method of claim 11 including optically interconnecting each of said processors.

21. An article comprising a medium storing instructions that enable a first processor-based system to:
identify a light communication from a second processor-based system intended for said first processor-based system;
tune to said wavelength; and
notify a third processor-based system that said first processor-based system is tuned to said wavelength.

22. The article of claim 21 further storing instructions that enable the first processor-based system to scan through a plurality of wavelengths of other processor-based systems to identify a signal intended for said first processor-based system.

23. The article of claim 21 further storing instructions that enable the first processor-based system to receive a code that indicates whether a given light communication is intended to be sent to said first processor-based system.

24. The article of claim 23 further storing instructions that enable said first processor-based system to tune to said wavelength to the exclusion of other wavelengths.

25. The article of claim 24 further storing instructions that enable said first processor-based system to broadcast a signal indicating that said first processor-based system is tuned exclusively to said wavelength.

26. The article of claim 25 further storing instructions that enable the first processor-based system to notify a third processor-based system when said first processor-based system is no longer engaged in a communication with said second processor-based system.

27. The article of claim 21 further storing instructions that enable said first processor-based system to identify a second processor-based system to communicate with and to determine whether said second processor-based system is currently occupied with a communication with another processor-based system.

28. The article of claim 21 further storing instructions that enable said first processor-based system to communicate with at least two other processor-based systems using optical communications and wavelength division multiplexing.

29. The article of claim 28 further storing instructions that enable said first processor-based system to communicate with other processor-based systems using an assigned wavelength.

30. The article of claim 29 further storing instructions that enable said first processor-based system to transmit a code that identifies said first processor-based system and an intended receiving processor-based system.
